(19) United States
(12) Patent Application Publication
(10) Pub. No.: US 2012/0201111 A1
(43) Pub. Date: Aug. 9, 2012

(54) OPTICAL DISK REPRODUCING DEVICE AND PHASE-LOCKED LOOP CIRCUIT

(75) Inventors: Yusuke Nakamura, Yokohama (JP); Masakazu Ikeda, Odawara (JP); Koichiro Nishimura, Yokohama (JP)

(73) Assignee: RENESAS ELECTRONICS CORPORATION, Kanagawa (JP)

(21) Appl. No.: 13/447,975

(22) Filed: Apr. 16, 2012

Related U.S. Application Data
(63) Continuation of application No. 12/328,113, filed on Dec. 4, 2008.

(30) Foreign Application Priority Data
Dec. 7, 2007 (JP) 2007-317206
Oct. 15, 2008 (JP) 2008-265950

(51) Int. Cl. G11B 27/36; G11B 7/00

(52) U.S. Cl. 369/53.12; G9B/27.052; G9B/7

(57) ABSTRACT

An optical disk reproducing device for controlling false detection of synchronization signals due to intersymbol interference, and stably improving accuracy of frequency acquisition of a phase locked loop (PLL) even when offset and so on occur. A signal width close to an original mark length is obtained to use for frequency acquisition of the PLL by, for example, using two different slice thresholds and taking a width between a rising of a result of slicing at one threshold and a falling of a result of slicing at the other threshold as a synchronization signal width. When asymmetric properties due to offset, asymmetry, etc. occur, an amount of corrections on the slice threshold is calculated, and it is reflected on a threshold previously set to always obtain a correct synchronization signal width.

### CROSS-REFERENCE TO RELATED APPLICATION

This application is a continuation of U.S. Ser. No. 12/328,113, filed Dec. 4, 2008, the entire contents of which are hereby incorporated by reference.

The present application claims priorities from Japanese Patent Application No. JP 2007-317206 filed on Dec. 7, 2007, and Japanese Patent Application No. JP 2008-265950 filed on Oct. 15, 2008, the contents of which are hereby incorporated by reference into this application.

### TECHNICAL FIELD OF THE INVENTION

The present invention relates to a synchronization detection circuit for an optical disk reproducing device which reproduces data from an optical disk. More particularly, the present invention relates to a phase-locked loop circuit.

### BACKGROUND OF THE INVENTION

Optical disks such as a compact disk (hereinafter, CD), DVD and the like are commonly used as a storage medium for storing a large amount of data. In recent years, high-density and large-capacity optical disk devices such as Blu-ray Disc (registered trademark) and HD DVD (registered trademark) having a larger capacity have also become common.

When reproducing an optical disk, it is required to acquire a clock frequency for a capture range of a PLL (phase-locked loop) to generate a clock synchronized with a reproduced signal. As specific methods thereof, for example, there are the following: I) A method of measuring an inversion interval after binarizing a reproduced signal, and then detecting a maximum value of the interval followed by controlling a rotational speed of the disk, so that the detected maximum value becomes a defined length; II) A method of measuring an inversion interval of a reproduced signal, and then detecting a maximum or a minimum value of the interval followed by setting a predetermined rotational speed of the disk based on a cycle of a detected synchronization signal.

However, when an intersymbol interference occurs in a reproduced waveform signal, a problem that synchronization signal period cannot be correctly detected could occur. That is, since a signal width larger than a signal width that should essentially appear is detected by slicing at zero level, a period which is not essentially assumed as the synchronization signal period could be detected.

As a means for solving the problem, Japanese Patent Application Laid-Open Publication No. H08-138328 (hereinafter Patent Document 1) proposes a technique in which, in a synchronization signal detection circuit, a signal waveform is sliced even at a signal level differing from a zero level and a synchronization signal is detected making an allowance for even a signal width at this time.

In addition, Japanese Patent Application Laid-Open Publication No. 2006-252640 (hereinafter, Patent Document 2) also discloses a technique in which, at a signal level differing from a zero level, a reference synchronization signal width is detected. Additionally, a technique in which a reference synchronization signal width is properly set up according to a state of offset or asymmetry of the reproduced signal waveform is also disclosed.

### SUMMARY OF THE INVENTION

However, in the invention of Patent Document 1, the signal width at a signal level different from the zero level is shorter than the original synchronization signal width. Acquiring this shortened signal to the PLL could lead to a failure of frequency acquisition.

Also, in the invention of Patent Document 2, when an offset occurs in the reproduced signal waveform, the reference synchronization signal width is changed according to the state of the offset and the like. Therefore, when an asymmetry occurs, the width would be further different from the original synchronization width.

An object of the present invention is to realize an optical disk reproducing device in which a false detection of the synchronization signal due to intersymbol interference is prevented and an accuracy of PLL frequency acquisition is stably improved even when an offset and an asymmetry occurs.

The above and other objects and novel characteristics of the present invention will be apparent from the description of this specification and the accompanying drawings.

The typical embodiments of the inventions disclosed in this application will be briefly described as follows.

An optical disk reproducing device according to a typical embodiment of the present invention includes: an analog front end (hereinafter, AFE) which performs an analog processing on an output of a pickup; an A-D converter (hereinafter, ADC) which converts an analog signal output from the AFE into a digital signal by using a reference frequency output from a voltage controlled oscillator (hereinafter, VCO); a frequency error detection circuit which detects a frequency error of an output from the ADC; a low-pass filter circuit (hereinafter, LPF) which removes a high frequency component of an output from the frequency error detection circuit; a D-A converter (hereinafter, DAC) which converts an output from the LPF into an analog signal; and the VCO which outputs a reference frequency based on an output from the DAC. The frequency error detection circuit includes: a first slice circuit which slices the output from the ADC at a first threshold; a second slice circuit which slices the output from the ADC at a second threshold; a signal width detection circuit which detects a signal width from the output from the first and second slice circuits; a maximum signal width detection circuit which compares the signal width output from the signal width detection circuit to its own signal width held in itself and records a longer one and outputs the same; and an error detection circuit which compares an output from the maximum signal width detection circuit to a target synchronization signal width previously set and outputs a difference therebetween.

Another optical disk reproducing device according to a typical embodiment of the present invention includes: an AFE which performs an analog processing on an output of the pickup; an ADC which converts an output analog signal from the AFE into a digital signal by using a reference frequency output from a VCO; a frequency error detection circuit which detects a frequency error of an output from the ADC; a phase error detection circuit which detects a phase error of the output from the ADC; a switch which selectively outputs an output from the frequency error detection circuit and an output from the phase error detection circuit; an LPF which removes a high frequency component of an output from the switch; a DAC which converts an output from the LPF into the analog signal; and the VCO which outputs a reference frequency based on an output from the DAC. The frequency error detection circuit includes: a first slice circuit which slices the output from the ADC at a first threshold; a second slice circuit which slices the output from the ADC at a second threshold; a signal width detection circuit which detects a signal width from the output from the first and the second slice circuit; a maximum signal width detection circuit which compares the signal width output from the signal width detection circuit to its own signal width held in itself and recording a longer one and outputs the same; and an error detection circuit which compares an output from the maximum signal width detection circuit to a target synchronization signal width previously set and outputs a difference therebetween.

The signal width detection circuit of these optical disk reproducing devices may detect one signal width by a combination of the output from the first slice circuit and the output from the second slice circuit.

The signal width detection circuit of these optical disk reproducing devices may detect a first signal width obtained from a combination of an edge information of the output from the first slice circuit and an edge information of the output from the second slice circuit, and also detect a second signal width obtained from a combination of the edge information of the output of the first slice circuit or a combination of the edge information of the output from the second slice circuit, and output the first signal width to the maximum signal width detection circuit when a difference between the first signal width and the second signal width is smaller than or equal to an acceptable amount previously set and output the second signal width to the maximum signal width detection circuit when the difference is larger than the acceptable amount.

The signal width detection circuit of these optical disk reproducing devices may detect: a first signal width by a combination of an edge information of the output from the first slice circuit; a second signal width by a combination of an edge information of the output from the second slice circuit; and a third signal width for a plurality of marks by a combination of the edge information of the output from the first slice circuit and the edge information of the output from the second slice circuit, and output the third signal width when a difference between the third signal width and a sum of the first signal width and the second signal width is smaller than or equal to an acceptable value previously set.

Another optical disk reproducing device according to a typical embodiment of the present invention comprises: an AFE which performs an analog processing on an output of a pickup; an ADC which converts an output analog signal from the AFE into a digital signal by using a reference frequency output from a VCO; a frequency error detection circuit which detects a frequency error of an output from the ADC; an LPF which removes a high frequency component of an output from the frequency error detection circuit; an DAC which converts an output from the LPF into an analog signal; and the VCO which outputs the reference frequency based on an output from the DAC. The frequency error detection circuit includes: an asymmetry amount measuring circuit which calculates a slice threshold correction amount from the output from the ADC and outputs the same; a first slice circuit which slices the output from the ADC at a first corrected threshold corrected by an output from the asymmetry amount measuring circuit; a second slice circuit which slices the output from the ADC at a second corrected threshold corrected by the output from the asymmetry amount measuring circuit; a signal width detection circuit which detects a signal width from an output from the first slice circuit and an output from the second slice circuit; a maximum signal width detection circuit which compares the signal width output from the signal width detection circuit to its own signal width held in itself and recording a longer one and outputs the same; and an error detection circuit which compares an output from the maximum signal width detection circuit to a target synchronization signal width previously set and outputs a difference therebetween.

Another optical disk reproducing device according to a typical embodiment of the present invention comprises: an AFE which performs an analog processing on an output of a pickup; an ADC which converts an output analog signal from the AFE into a digital signal by using a reference frequency output from a VCO; a frequency error detection circuit which detects a frequency error of an output from the ADC; an LPF which removes a high frequency component of an output from the frequency error detection circuit; a DAC which converts an output from the LPF into an analog signal; and the VCO which outputs a reference frequency based on an output from the DAC. The frequency error detection circuit may include: a first slice circuit which slices the output from the ADC at a first threshold; a second slice circuit which slices the output from the ADC at a second threshold; a signal width detection circuit which detects the signal width from the output from the first and second slice circuits; a synchronization signal detection circuit which compares a synchronization signal width previously set to an output from the signal width detection circuit, and determines whether the signal is a synchronization signal or not; a synchronization signal period measuring circuit which measures a synchronization signal period from an output from the synchronization signal detection circuit; and an error detection circuit which compares an synchronization signal period previously set to an output from the synchronization signal period measuring circuit and outputs an error therebetween.

A phase-locked loop circuit according to a typical embodiment of the present invention includes: an ADC which converts an analog signal into a digital signal by using a reference frequency output from a VCO; and a frequency error detection circuit which detects a frequency error of an output from the ADC. The frequency error detection circuit includes: a first slice circuit which slices the output from the ADC at a first threshold; a second slice circuit slicing the output from the ADC at a second threshold; a signal width detection circuit which detects a signal width from outputs from the first and second slice circuits; a maximum signal width detection circuit which compares a signal width output from the signal width detection circuit to its own signal width held in itself and records a longer one and outputs the same; and an error detection circuit which compares an output from the maximum signal width detection circuit to a target synchronization signal width previously set and outputs a difference therebetween.

Another phase-locked loop circuit according to a typical embodiment of the present invention includes: an ADC which converts an analog signal into a digital signal by using a reference frequency output from a VCO; and a frequency error detection circuit which detects a frequency error of an output from the ADC. The frequency error detection circuit includes: an asymmetry amount measuring circuit which calculates a slice threshold correction amount from the output from the ADC and outputs the same; a first slice circuit which slices the output from the ADC at a first corrected threshold corrected by an output from the asymmetry amount measuring circuit; a second slice circuit which slices the output from the ADC with a second corrected threshold corrected with the output from the asymmetry amount measuring circuit; a signal width detection circuit which detects a signal width from an output from the first slice circuit and an output from the second slice circuit; a maximum signal width detection circuit which compares a signal width output from the signal width detection circuit to its own signal width held in itself and records a longer one and outputs the same; and an error detection circuit which compares an output from the maximum signal width detection circuit to a target synchronization signal width previously set and outputs a difference therebetween.

Another phase-locked loop circuit according to a typical embodiment of the present invention includes: an ADC which performs an analog-to-digital conversion on an input signal by using a reference frequency output from a VCO; and a frequency error detection circuit which detects a frequency error of an output from the ADC. The frequency error detection circuit includes: an asymmetry amount measuring circuit which calculates a slice threshold correction amount from the output from the ADC and outputs the same; a first slice circuit which slices the output from the ADC at a first corrected threshold corrected by an output from the asymmetry amount measuring circuit; a second slice circuit which slices the output from the ADC at a second corrected threshold corrected by the output from the asymmetry amount measuring circuit; a signal width detection circuit which detects a signal width from an output from the first slice circuit and an output from the second slice circuit; a synchronization signal detection circuit which compares the synchronization signal width previously set to an output from the signal width detection circuit and determines whether the signal is a synchronization signal or not; a synchronization signal period measuring circuit which measures a synchronization signal period from an output from the synchronization signal detection circuit; and an error detection circuit which compares a synchronization signal period previously set and an output from the synchronization signal period measuring circuit and outputs an error therebetween.

These phase-locked loop circuits may also comprise: a phase error detection circuit which detects a phase error of the output from the ADC; and a switch which selectively outputs an output from the frequency error detection circuit and an output from the phase error detection circuit.

In these phase-locked loop circuits, the signal width detection circuit may detect one signal width by a combination of the output from the first slice circuit and the output from the second slice circuit.

The signal width detection circuit of these phase-locked loop circuits may detect a first signal width obtained from a combination of an edge information of the output from the first slice circuit and an edge information of the output from the second slice circuit, and also detect a second signal width obtained from a combination of the edge information of the output of the first slice circuit or the edge information of the output from the second slice circuit; and output the first signal width to the maximum signal width detection circuit when a difference between the first signal width and the second signal width is less than or equal to an acceptable amount previously set or output the second signal to the maximum signal width detection circuit when the difference is larger than the acceptable amount.

The signal width detection circuit of these phase-locked loop circuits may detect: a first signal width in combination of an edge information of the output from the first slice circuit; a second signal width in combination of an edge information of the output from the second slice circuit; a third signal width for a plurality of marks by a combination of the edge information of the output from the first slice circuit and the edge information of the output from the second slice circuit, and output the third signal width when a difference between the third signal width and an addition of the first signal width and the second signal width is less than or equal to an acceptable value previously set.

An optical disk reproducing device using these phase-locked loop circuits is also in the range of the present invention.

The effects obtained by typical aspects of the present invention will be briefly described below.

According to the optical disk reproducing device according to typical embodiments of the present invention, a synchronization signal can be correctly detected even in a situation where an intersymbol interference is large in such a case of reproducing a high-density recording medium and the like and a synchronization signal detection easily fails due to an amplitude reduction of a short-mark signal, thereby improving the accuracy of the frequency acquisition of the PLL. Also, the synchronization signal can be stably detected even when asymmetrical properties such as an asymmetry and offset occur in the reproduced signal waveform.

### BRIEF DESCRIPTION OF THE DRAWINGS

FIG. 1 is a block diagram showing a configuration of an optical disk reproducing device according to a first embodiment of the present invention;

FIG. 2 is a block diagram showing a configuration of a first frequency error detection circuit according to the first embodiment of the present invention;

FIG. 3 is a diagram schematically showing a synchronization signal detection of the optical disk reproducing device of the present invention;

FIG. 4A is a diagram showing a pattern used in a method of synchronization signal detection of a signal width detection circuit;

FIG. 4B is a diagram showing a pattern used in the method of synchronization signal detection of the signal width detection circuit;

FIG. 4C is a diagram showing a pattern used in the method of synchronization signal detection of the signal width detection circuit;

FIG. 5 is a configuration diagram of a first frequency error detection circuit in an optical disk reproducing device according to a fourth embodiment of the present invention;

FIG. 6 is a schematic diagram of a waveform for describing an operation of an asymmetry amount measuring circuit in an operation of the frequency error detection circuit according to the fourth embodiment of the present invention;

FIG. 7 is a block diagram showing a configuration of the asymmetry amount measuring circuit according to the fourth embodiment of the present invention;

FIG. 8 is a block diagram showing a configuration of a second frequency error detection circuit in an optical disk reproducing device according to a fifth embodiment of the present invention;

FIG. 9 shows a configuration diagram of a first frequency error detection circuit in an optical disk reproducing device according to a sixth embodiment of the present invention;

FIG. 10 shows a configuration diagram of a first frequency error detection circuit in an optical disk reproducing device according to a seventh embodiment of the present invention; and

FIG. 11 shows a configuration diagram of a signal width detection circuit in an optical disk reproducing device according to the second and third embodiments of the present invention.

### DESCRIPTIONS OF THE PREFERRED EMBODIMENTS

Hereinafter, embodiments of the present invention will be described in detail with reference to the accompanying drawings.

### First Embodiment

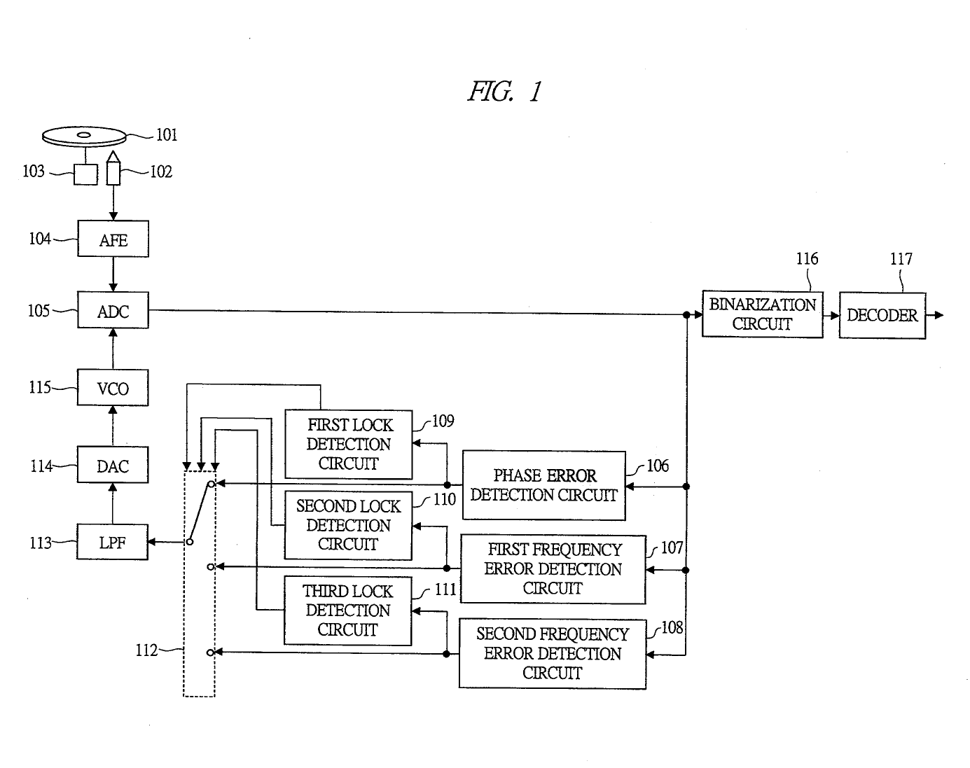

FIG. 1 is a block diagram showing a configuration of an optical disk reproducing device according to a first embodiment of the present invention.

The optical disk reproducing device of FIG. 1 includes an optical disk 101, an optical pickup 102, a spindle motor 103, an AFE 104, an ADC 105, a phase error detection circuit 106, a first frequency error detection circuit 107, a second frequency error detection circuit 108, a first lock detection circuit 109, a second lock detection circuit 110, a third lock detection circuit 111, a changeover switch 112, an LPF 113, a DAC 114, a VCO 115, a binarization circuit 116, and a decoder 117.

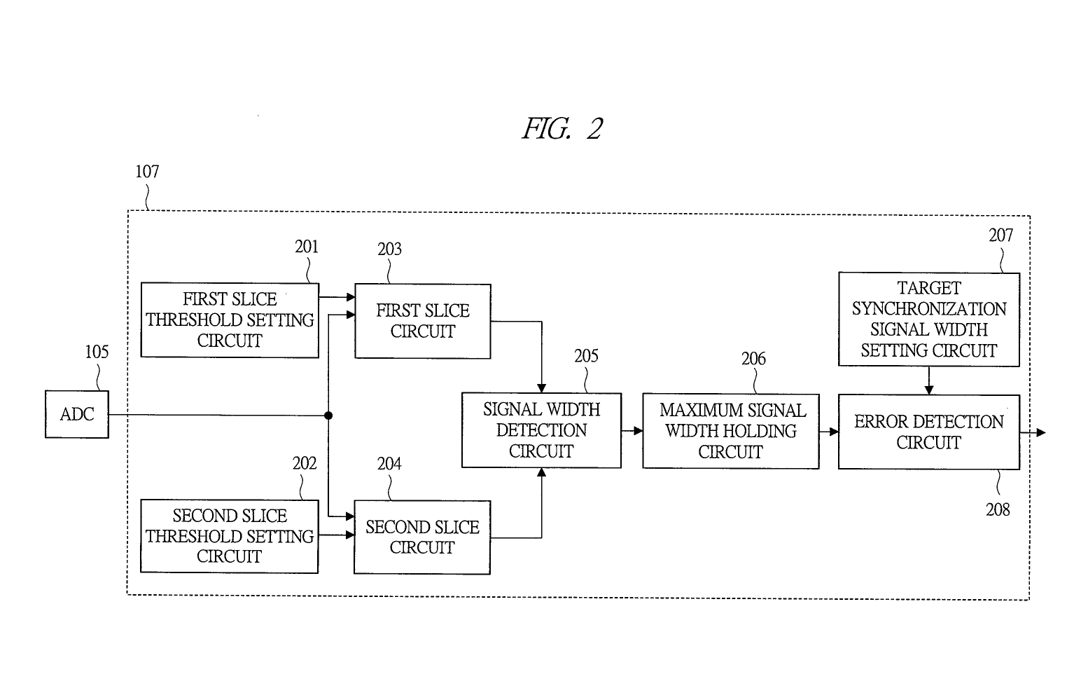

Further, FIG. 2 is a block diagram showing a configuration of the first frequency error detection circuit 107 according to the first embodiment of the present invention. This frequency error detection circuit 107 includes a first slice threshold setting circuit 201, a second slice threshold setting circuit 202, a first slice circuit 203, a second slice circuit 204, a signal width detection circuit 205, a maximum signal width holding circuit 206, a target synchronization signal width setting circuit 207, and an error detection circuit 208.

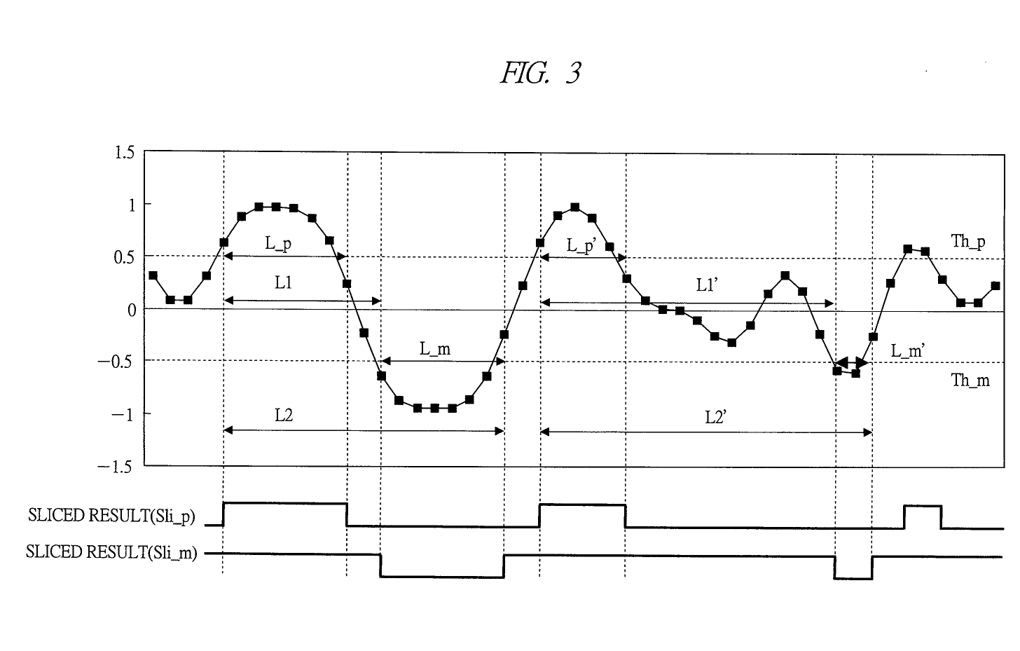

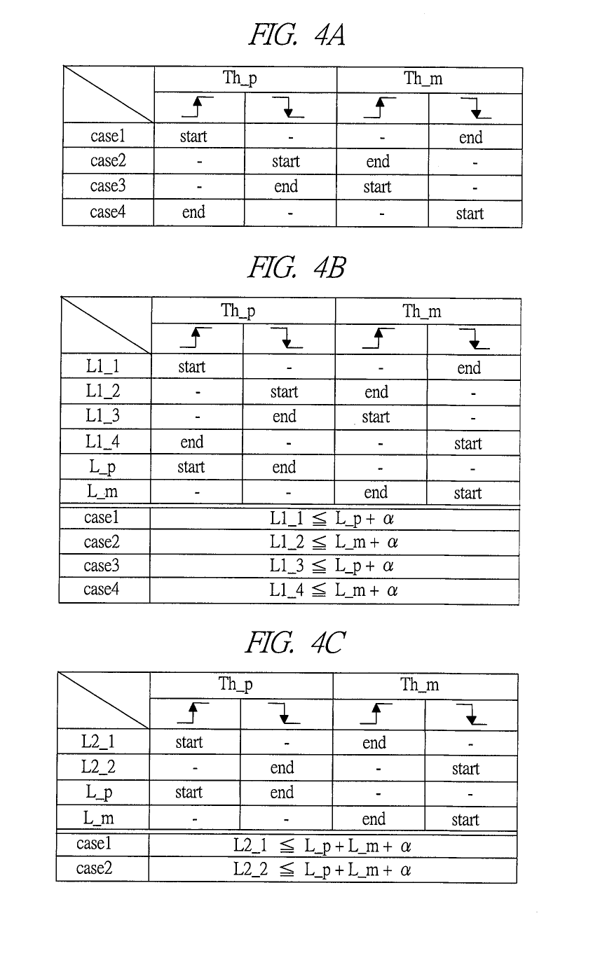

FIG. 3 is a diagram conceptually showing a synchronization signal detection of the optical disk reproducing device of FIG. 1 and FIG. 2. Further, FIGS. 4A to 4C are diagrams each showing a pattern used in a synchronization signal detection method of the signal width detection circuit 205.

The optical disk 101 is a recording medium to be reproduced.

The optical pickup 102 is an optical element having a light source for a laser beam and a light receiving part receiving reflected light which is emitted from the light source and reflected on the optical disk 101. Optical information detected by the optical pickup is outputted to the AFE 104 as an analog signal.

The spindle motor 103 is a motor which rotates the optical disk 101.

The AFE 104 is a component which performs operations such as an amplification of the analog signal output from the optical pickup 102 and an adjustment of a waveform for use at the ADC 105. The AFE 104 outputs the corrected analog signal described above to the ADC 105.

The ADC 105 is a component which converts the analog signal output from the AFE 104 into a digital signal and outputs the same to the phase error detection circuit 106, the first frequency error detection circuit 107, the second frequency error detection circuit 108, and the binarization circuit 116. The ADC 105 is operated by a reference frequency of the VCO 115.

The phase error detection circuit 106 detects a phase error from a data shift at an edge of a reproduced waveform outputted from the ADC 105, and outputs the phase error to the first lock detection circuit 109 and the changeover switch 112 as an error signal.

The first frequency error detection circuit 107 detects a frequency error from a synchronization signal width detected from the reproduced waveform, and outputs the frequency error to the second lock detection circuit 110 and the changeover switch 112 as an error signal.

The second frequency error detection circuit 108 detects a frequency error from a period between synchronization signals detected from the reproduced waveform, and outputs the frequency error to the third lock detection circuit 111 and the changeover switch 112 as an error signal.

The first lock detection circuit 109 outputs a lock signal to the changeover switch 112 when the error signal sent from the phase error detection circuit 106 is within an error range previously set.

The second lock detection circuit 110 also outputs a lock signal to the changeover switch 112 when the error signal sent from the first frequency error detection circuit 107 is within an error range previously set.

The third lock detection circuit 111 also outputs a lock signal to the changeover switch 112 when the error signal sent from the second frequency error detection circuit 108 is within the error range previously set.

The changeover switch 112 is a switching circuit for outputting any of the outputs from the phase error detection circuit 106, the first frequency error detection circuit 107, and the second frequency error detection circuit 108 to the LPF 113 using the lock signal inputs from the first lock detection circuit 109, the second lock detection circuit 110, and the third lock detection circuit 111 as a control signal. As an example of a specific control method of the control signal described above, the following is considered.

Among the detection accuracies that the phase error detection circuit 106, the first frequency error detection circuit 107, and the second frequency error detection circuit 108 described above have, the phase error detection circuit 106 has the highest one, the second frequency error detection circuit 108 has the next one, and the first frequency error detection circuit 107 has the lowest one, in order. However, the frequency could be twice as much than another even when the phases match. Therefore, differing form the detection accuracy, in switching of the changeover switch 112, the second lock detection circuit 110 is given the highest priority, and a determination of the third lock detection circuit 111 is performed only when the second lock detection circuit 110 is locked. And, when these two locks are confirmed, a determination of the first lock detection circuit 109 is performed for the first time to activate the output from the phase error detection circuit 106 having the highest accuracy.

The LPF 113 is a low pass filter for converting the output from the changeover switch 112 into a direct current signal having few alternating current components for preventing an oscillation. An output from the LPF 113, where high frequency components are removed, is outputted to the DAC 114.

The DAC 114 is a digital-to-analog conversion circuit for converting the digital signal output from the LPF 113 into an analog signal. After being converted into an analog signal by the DAC 114, the signal is outputted to the VCO 115.

The VCO 115 is a variable frequency oscillator which operates making an allowance for the output from the DAC 114. An output from the VCO 115 is outputted to the ADC 105 as a reference frequency. The reference frequency is used as a sampling clock at the ADC 105.

The binarization circuit 116 decodes a multivalued reproduced waveform data to binary data by using PRML (Partial Response Maximum Likelihood) and the like.

The decoder 117 performs a decoding process on the output from the binarization circuit 116, an error correcting arithmetic process, a descrambling process, and a data output control to the external.

The first slice threshold setting circuit 201 is a register circuit for setting one of two different thresholds. Also, the second slice threshold setting circuit 202 is a register circuit for setting the other threshold. These two thresholds correspond to Th_p and Th_m of FIG. 3.

The first slice circuit 203 compares an output from the ADC 105 to an output from the first slice threshold setting circuit 201, and when the two outputs are substantially same, the first slice circuit 203 outputs a first slice detection signal to the signal width detection circuit 205. In the same manner, the second slice circuit 204 compares the output from the ADC 105 to an output from the second slice threshold setting circuit 202, and when the two outputs are almost same, the second slice circuit 204 outputs a second slice detection signal to the signal width detection circuit 205.

In the present embodiment, it is determined whether the output from the ADC 105 is going toward the 0 level or going away from the 0 level. Therefore, the outputs of the first slice circuit 203 and the second slice circuit 204 are required to be only 1 bit, respectively. The output from the first slice circuit 203 is indicated by Sli_p in FIG. 3, and the output from the second slice circuit 204 is indicated by Sli_m in FIG. 3. And, the changing point from 0 to 1 or 1 to 0 in Sli_p and Sli_m is defined as “edge information” herein.

The signal width detection circuit 205 is a circuit which measures a time width between the slices depending on change of the first slice detection signal and the second slice detection signal. The time measured at this time is outputted to the maximum signal width holding circuit 206.

The maximum signal width holding circuit 206 is a circuit which records the output from the signal width detection circuit 205 and outputs the same to the error detection circuit 208. Note that the present invention has a feature in operations of the signal width detection circuit 205 and the maximum signal width holding circuit 206, and specific descriptions thereof will be made later.

The target synchronization signal width setting circuit 207 outputs a signal width to be a reference of synchronous decision to the error detection circuit 208.

The error detection circuit 208 is a circuit which compares an output from the maximum signal width holding circuit 206 to an output from the target synchronization signal width setting circuit 207. A difference between these two signals is calculated, and the difference is outputted to the second lock detection circuit 110 and the changeover switch 112 as an error signal.

Hereinafter, an outline of a reproducing operation of the optical disk reproducing device according to the present embodiment will be described.

As shown in FIG. 1, a signal read by the optical pickup 102 irradiating the optical disk 101 with a laser beam and receiving the reflected light from the disk is subjected to an analog process at the AFE 104 and inputted into the ADC 105. The signal is digitized at the ADC 105 and inputted into the phase error detection circuit 106. The phase error detection circuit 106 detects a phase error from a data shift at an edge of the reproduced waveform, and outputs the same to the first lock detection circuit 109 and the changeover switch 112 as an error signal. And, at the same time, an output from the ADC 105 is inputted into the first frequency error detection circuit 107, and then the first frequency error detection circuit 107 detects a frequency error from the synchronization signal width detected from the reproduced waveform and outputs the same to the second lock detection circuit 110 and the changeover switch 112 as an error signal. Further, at the same time, the output from the ADC 105 is inputted into the second frequency error detection circuit 108, and then the second frequency error detection circuit 108 detects a frequency error from a period between the synchronization signals detected from the reproduced waveform and outputs the same to the third lock detection circuit 111 and the changeover switch 112 as an error signal.

Based on the setting of the changeover switch 112, a signal from any one of the phase error detection circuit 106, the first frequency error detection circuit 107, and the second frequency error detection circuit 108 is outputted to the LPF 113 as an error signal. High frequency components are removed from the error signal at the LPF 113, and then, the error signal is converted into an analog signal at the DAC 114 and inputted into the VCO 115. The VCO 115 adjusts a period and a phase of the sampling clock of the ADC 105 so as to compensate a phase difference and a frequency difference according to the obtained error signal.

As described in the foregoing, an output from the ADC 105 sampled in synchronization with the input data is decoded into binary data from multivalue reproduced waveform data by using the PRML and the like at the binarization circuit 116. And, the decoding process of the binary data, the error correcting arithmetic process, and the descrambling process, and the data output control to the external are performed at the decoder 117.

Next, operation of the first frequency error detection circuit 107 will be described. It will be described as follows while assuming that setting has already been made on the first slice threshold setting circuit 201 and the second slice threshold setting circuit 202.

A reproduced signal waveform output from the ADC 105 and the output Th_p from the first slice threshold setting circuit 201 are inputted into the first slice circuit 203, and then, the first slice circuit 203 outputs a sliced result from a difference value between the reproduced signal waveform and Th_p (Sli_p in FIG. 3). In the same manner, the reproduced signal waveform output from the ADC 105 and the output Th_m from the second slice threshold setting circuit 202 are inputted into the second slice circuit 204, and the second slice circuit 204 outputs a sliced result from a difference value between the reproduced signal waveform and Th_m (Sli_m in FIG. 3). Note that, since the synchronization signal generally has the largest run length among reproducing data, an amplitude thereof is large, and thus slicing can be done even at a level other than 0 level. Herein, the run length means the number of times “0” or “1” consecutively appears in a bit string of read data. The sliced result obtained at these slice circuits is inputted into the signal width detection circuit 205.

The signal width detection circuit 205 detects a signal width according to a signal width detecting pattern of FIG. 4A. A counting of the signal width starts from the edge indicated by “start” in FIG. 4A, and the number of data till another edge indicated by “end” is counted and taken as the signal width. For example, in a case 1 of FIG. 4A, the number from the rising timing of Sli_p till the falling timing of Sli_m is detected as the signal width (L1 in FIG. 3). When the signal width is detected using only the sliced result that used either Th_p or Th_m (L_p and L_m in FIG. 3), the width is shorter than the sliced result at 0 level, while a result close to the original signal width can be outputted by using the signal width L1 of FIG. 3.

The signal width obtained in this manner is inputted into the maximum signal width holding circuit 206. And the maximum signal width holding circuit 206 detects the largest one among the signal widths measured for a certain fixed period (for example, a period of one sync frame), and outputs the same as a synchronization signal width. The signal width set up as a reference at the target synchronization signal width setting circuit 207 and the signal width output from the maximum signal width holding circuit 206 are inputted into the error detection circuit 208, and the error detection circuit 208 calculates a difference value between the two signal widths, and outputs the same as an error signal.

By using the synchronization signal detection using the slices at the two different thresholds described above, a false synchronization signal detection due to the fact that a short mark is not crossed at 0 level by intersymbol interference and others can be prevented. Also, the synchronization signal width to be detected can be the one being close to the original mark length, thereby improving the accuracy of the frequency acquisition of the PLL.

### Second Embodiment

Next, a second embodiment of the present invention will be described. An object of the present embodiment is to prevent a false detection in a synchronization signal detection. A difference from the optical disk reproducing device according to the first embodiment is the signal width detection circuit 205 in FIG. 2.

According to the signal width detecting method of the first embodiment, when the amplitude of a short mark signal is small due to intersymbol interference as shown by L1′ in FIG. 3, there is a possibility that a signal corresponding to a plurality of marks is detected as the signal width. Therefore, a signal width L_p′ or L_m′ of only one threshold is used to set up detection conditions.

For example, in the case of case 1 in FIG. 4B, a width from the rising timing of Sli_p till a falling timing of Sli_m is detected as the signal width (L1′ in FIG. 3) as shown by L1_1 in FIG. 4B. Also, the signal width from the rising timing of Sli_p till the falling timing thereof (L_p′ of FIG. 3) is detected as shown with L_p in FIG. 4B. A difference (L1′−L_p′) between them is determined whether being less than or equal to an acceptable amount α previously set or not. And, when the difference is less than or equal to α, L1′ is considered to include only one mark and outputted, and when the difference is larger than α, L1′ is considered to include a plurality of marks and L_p′ is outputted or not outputted. Also, the acceptable amount α can be arbitrarily set, but in general, when a plurality of marks are included in a detected signal width such as L1′, two or more signals of the minimum run length should be accompanied in one signal even at the shortest. This is because, if the number of accompanied signal is one, the signal from the rising of Sli_p till the falling of Sli_m is not provided. Therefore, in the case of media such as Blu-ray Disc (registered trademark), since the minimum run length is 2, the acceptable amount α is preferably around 4T (T indicates a data width of 1 bit), but it is not limited to this.

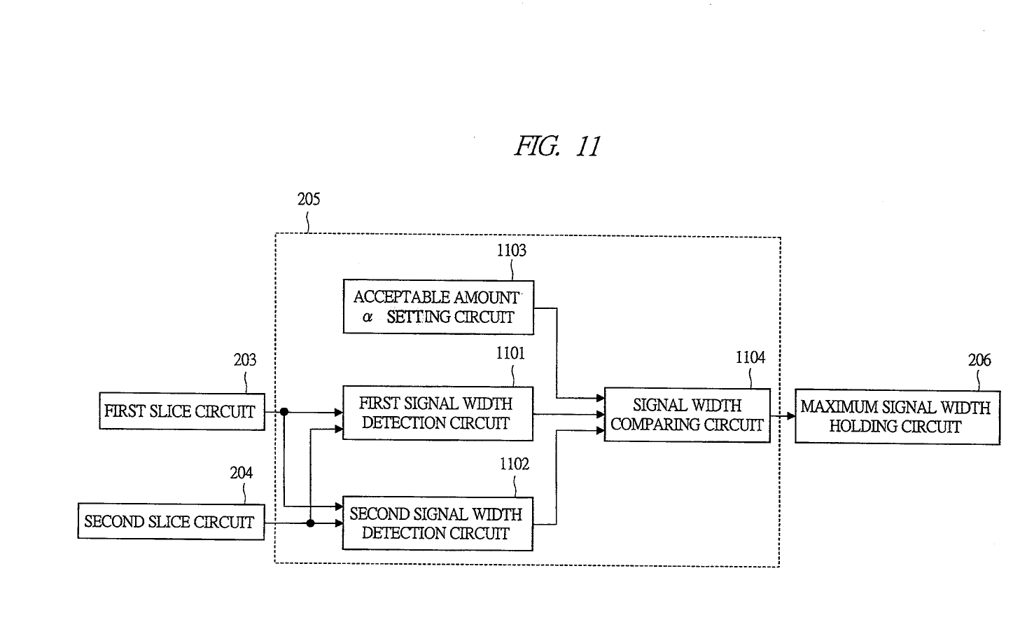

Further, FIG. 11 shows the signal width detection circuit 205 in detail. At first, an output from a first slice circuit 203 and an output from a second slice circuit 204 are inputted into a first signal width detection circuit 1101, and L2_1 and L2_2 of FIG. 4C are detected. Also, the output from the first slice circuit 203 and the output from the second slice circuit 204 are also inputted into a second signal width detection circuit 1102, and L_p and L_m are detected. Next, the acceptable amount α is stored in a set value of an acceptable amount α setting circuit 1103, and the set value is previously set by a register setting and the like by a user. The outputs from the first signal width detection circuit 1101, the second signal width detection circuit 1102, and the acceptable amount α setting circuit 1103 are inputted into a signal width comparing circuit 1104, and it is determined for them whether the conditions of case 1 and case 2 of FIG. 4C are satisfied or not, and then, the signal width which satisfies the conditions is inputted into the maximum signal width holding circuit 206.

By using the signal width detecting method described above, a false detection due to intersymbol interference is prevented, and the synchronization signal width to be detected can be the one that is close to the original mark length, thereby improving the accuracy of the frequency acquisition of the PLL.

### Third Embodiment

Next, a third embodiment of the present invention will be described. The present embodiment aims to improve a detection accuracy of the synchronization signal. A difference from the optical disk reproducing device according to the first embodiment is the signal width detection circuit 205 in FIG. 2. In the method for the synchronization signal detection of the first embodiment, since the synchronization signal has the largest run length among the reproduced data, the signal width of one mark is detected. However, since a repetition of the maximum run length (for example, 9T-9T) is used as the synchronization signal depending on the reproducing media, the accuracy of the detection can be improved by detecting the lengths of two or more patterns. For example, in the case of case 1 in FIG. 4C, the signal width detection circuit 205 detects the width from the rising timing of Sli_p till the rising timing of Sli_m (L2 of FIG. 3) as the synchronization signal width as shown by L2_1 of FIG. 4C.

However, also in this detection method, when the amplitude of the short mark signal is small due to intersymbol interference, since there is a possibility that the signal width configured by a plurality of marks is mistakenly detected as the synchronization signal (L2′ in FIG. 3), a protection is required to be provided. The second embodiment can be applied to this method. For example, the signal width L_p′ from the rising timing of Sli_p till the falling timing of the same is detected, and further, the signal width L_m′ from the falling timing of Sli_m and the rising timing of the same is detected. By giving a condition that the difference between L2′ and an addition of the signal widths L_p′ and L_m′ (L2′−(L_p′+L_m′)) is less than or equal to the acceptable amount α, a protection can be provided. As described above, while it is preferable to make the acceptable amount α to around 4T, it is not limited to this.

Also, FIG. 11 shows the signal width detection circuit 205 in detail. First, the output from the first slice circuit 203 and the output from the second slice circuit 204 are inputted into the first signal width detection circuit 1101, and L1_1, L1_2, L1_3, and L1_4 in FIG. 4B are detected. Also, the output from the first slice circuit 203 and the output from the second slice circuit 204 are inputted into the second signal width detection circuit 1102, and L_p and L_m are detected. Next, the acceptable amount α is stored in a set value of the acceptable amount α setting circuit 1103, and the set value is previously set in a register setting and the like by a user. The outputs from the first signal width detection circuit 1101, the second signal width detection circuit 1102, and the acceptable amount α setting circuit 1103 are inputted into the signal width comparing circuit 1104, and it is determined for them whether conditions of case 1 to case 4 of FIG. 4B are satisfied or not, and then the signal width which satisfies the conditions is inputted into the maximum signal width holding circuit 206.

By using the synchronization signal detecting method described above, a false of the synchronization signal detection can be less prone to occur than with the detection by one mark, thereby improving the accuracy of the frequency acquisition of the PLL.

### Fourth Embodiment

Next, a fourth embodiment of the present invention will be described.

An object of the present embodiment is, upon performing the synchronization signal detection using slices of two different thresholds, to stably detect the synchronization signal by correcting the slice threshold when asymmetrical properties such as offset and asymmetry occur.

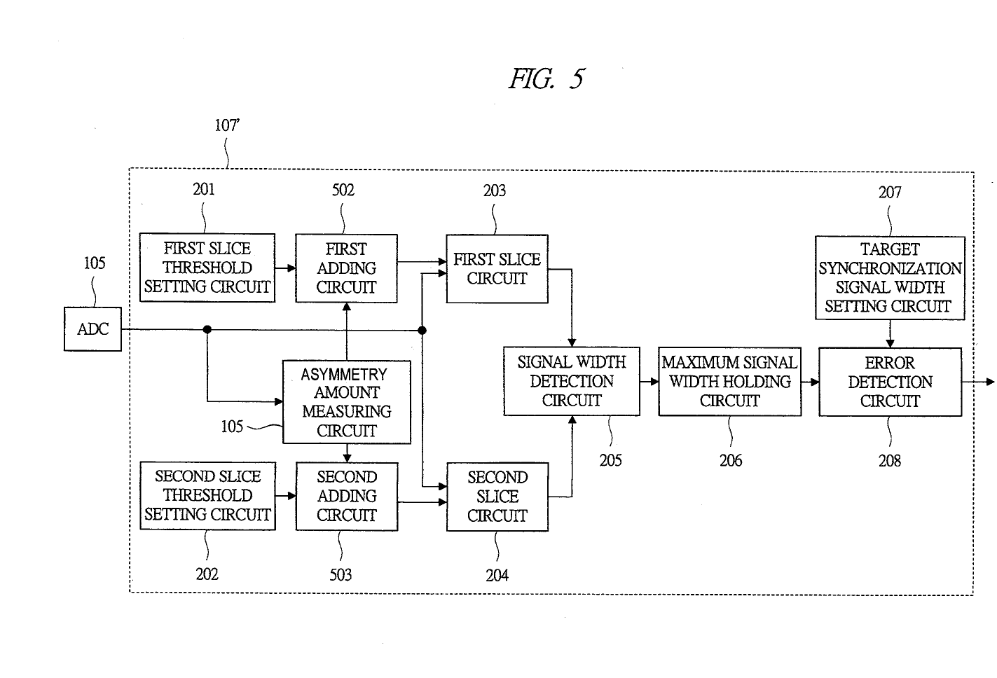

FIG. 5 shows a configuration diagram of a first frequency error detection circuit 107′ in an optical disk reproducing device according to the present embodiment.

The first frequency error detection circuit 107′ includes the first slice threshold setting circuit 201, the second slice threshold setting circuit 202, the first slice circuit 203, the second slice circuit 204, the signal width detection circuit 205, the maximum signal width holding circuit 206, the target synchronization signal width setting circuit 207, and the error detection circuit 208 included in the first frequency error detection circuit 107 of FIG. 2, and in addition, an asymmetry amount measuring circuit 501, a first adding circuit 502, and a second adding circuit 503 are included.

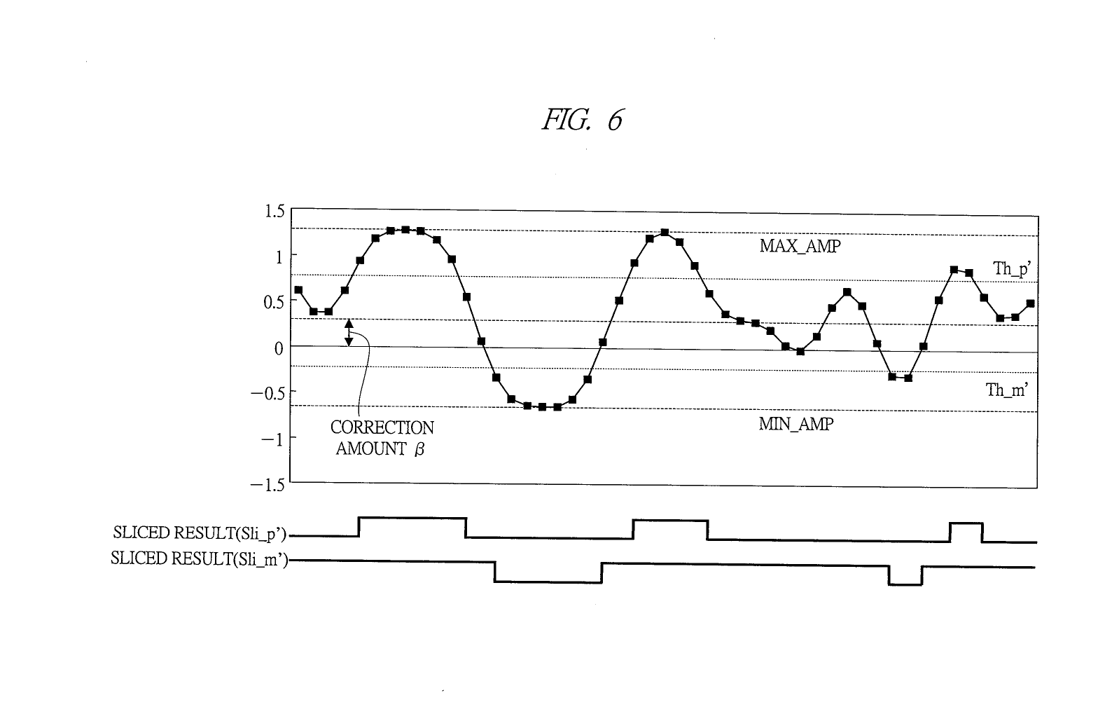

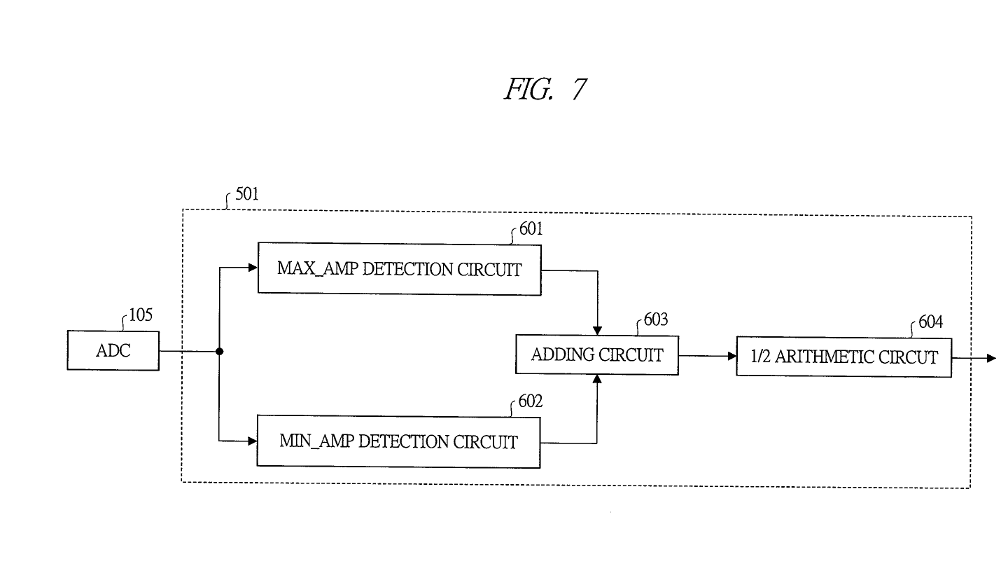

And, FIG. 6 is a schematic diagram of a waveform for describing an operation of the asymmetry amount measuring circuit 501 in an operation of the first frequency error detection circuit 107′, and FIG. 7 is a block diagram showing a configuration of the asymmetry amount measuring circuit 501.

The asymmetry amount measuring circuit 501 is configured by a MAX_AMP detection circuit 601, a MIN_AMP detection circuit 602, an adding circuit 603, and a ½ arithmetic circuit 604.

Hereinafter, descriptions will be made with focusing on differences from FIG. 2.

In FIG. 5, the first slice threshold setting circuit 201 and the second slice threshold setting circuit 202 are the same as those of FIG. 2 in configuration. However, the difference is that a correction is performed via the adding circuit before inputting into a corresponding slice circuit.

The asymmetry amount measuring circuit 501 is a circuit which detects a waveform bias related to the output data from the ADC 105. The “bias” in this case means, taking FIG. 6 as an example, that the waveform is shifted either to the positive side or to the negative side from the zero level.

The MAX_AMP detection circuit 601 in the asymmetry amount measuring circuit 501 detects a maximum value (MAX_AMP) of an input signal. And, the MIN_AMP detection circuit 602 detects a minimum value (MIN_AMP) of the same signal.

After the adding circuit 603 adds an output from the MAX_AMP detection circuit 601 and an output from the MIN_AMP detection circuit 602, the ½ arithmetic circuit 604 divides the value by 2, thereby obtaining the waveform bias. This value is regarded as a correction amount β.

A reason for detecting the “bias” by such a process is it is appropriate to determine the correction amount based on an envelope because a synchronization signal to be detected generally has the largest run length among reproduced data and thus has the largest amplitude.

The first adding circuit 502 adds the output of the first slice threshold setting circuit 201 (Th_p) and an output of the asymmetry amount measuring circuit 501 (the correction amount β), and outputs the obtained value to the first slice circuit 203. An output from the first adding circuit 502 corresponds to Th_p′ in FIG. 6. In the same manner, the second adding circuit 503 adds the output of the second slice threshold setting circuit 202 (Th_m) and the output of the asymmetry amount measuring circuit 501 (the correction amount β), and outputs the obtained value to the second slice circuit 204. An output from the second adding circuit 503 corresponds to Th_m′ in FIG. 6.

Next, a reproduced signal waveform output from the ADC 105 and the output Th_p′ from the first adding circuit 502 are inputted into the first slice circuit 203, and the first slice circuit 203 outputs a sliced result (Sli_p′ in FIG. 6) from the difference value between the reproduced signal waveform and Th_p′. In the same manner, the reproduced signal waveform output from the ADC 105 and the output Th_m′ from the second adding circuit 503 are inputted into the second slice circuit 204, and the second slice circuit 204 outputs a sliced result (Sli_m′ in FIG. 6) from a difference value between the reproduced signal waveform and Th_m′. Subsequent reproducing operations are the same as the first embodiment.

By using the signal width detecting method described above, since the signal width is measured with the compensated threshold, the synchronization signal width can be stably detected even when asymmetrical properties such as offset and asymmetry occur, thereby improving the accuracy of the frequency acquisition of the PLL.

Note that, in the present embodiment, a peak hold is used in the envelope calculation. However, it is not limited to this, and other envelope calculations are also applicable. Also, the calculation method of the correction amount is not limited to the present method. There can be other methods of obtaining a DC component.

### Fifth Embodiment

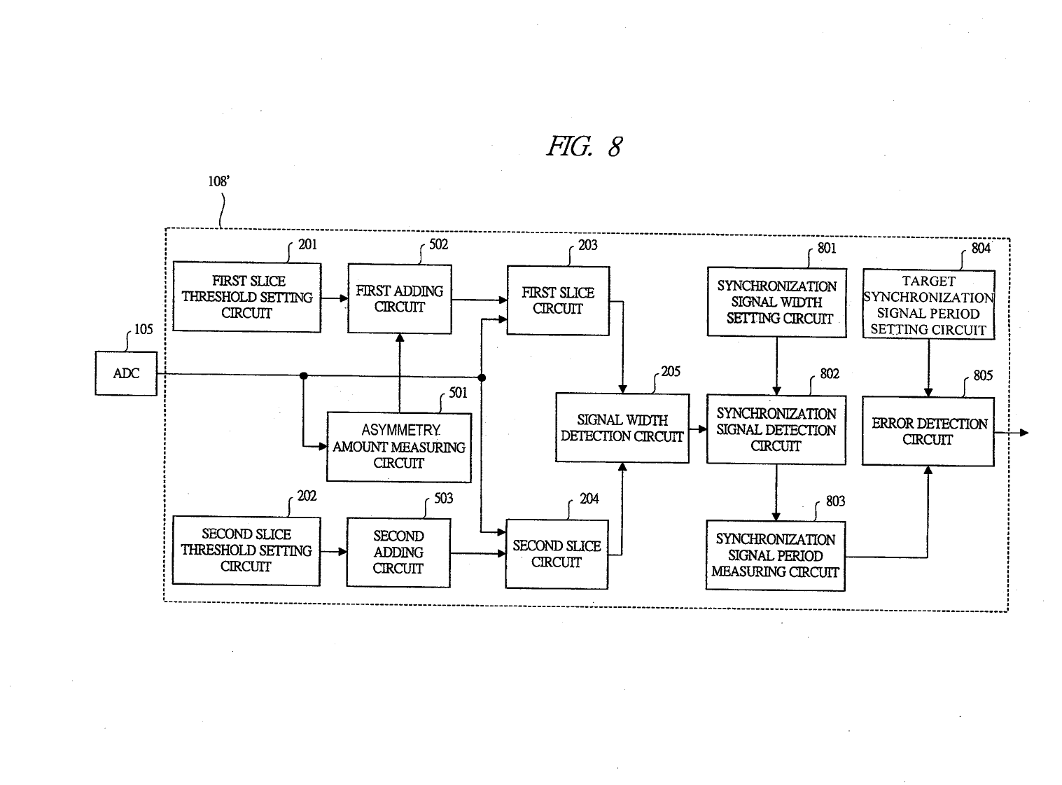

Next, a fifth embodiment of the present invention will be described. FIG. 8 is a block diagram showing a configuration of a second frequency error detection circuit 108′ in an optical disk reproducing device according to the fifth embodiment of the present invention. In the present embodiment, the synchronization signal detection using slices by two different thresholds is adapted to the frequency acquisition of the PLL with the synchronization signal period.

To compare the second frequency error detection circuit 108′ according to the present embodiment and the first frequency error detection circuit 107′ according to the fourth embodiment, there is a common point including the first slice threshold setting circuit 201, the second slice threshold setting circuit 202, the first slice circuit 203, the second slice circuit 204, the signal width detection circuit 205, the asymmetry amount measuring circuit 501, the first adding circuit 502, and the second adding circuit 503. On the other hand, handling of an output from the signal width detection circuit 205 is greatly different. In the present embodiment, the output is processed by a synchronization signal width setting circuit 801, a synchronization signal detection circuit 802, a synchronization signal period measuring circuit 803, a target synchronization signal period setting circuit 804, and an error detection circuit 805.

The synchronization signal width setting circuit 801 is a register to which a synchronization signal width to be a reference is set. An output from the synchronization signal width setting circuit 801 is outputted to the synchronization signal detection circuit 802.

To the synchronization signal detection circuit 802, the outputs from the signal width detection circuit 205 and the synchronization signal width setting circuit 801 described above are inputted. The two signal widths are compared, and when the signal widths match or are within an allowable range previously set, the signal is assumed to be a synchronization signal, and a synchronization signal detection timing is outputted to the synchronization signal period measuring circuit 803.

The synchronization signal period measuring circuit 803 measures a period between the synchronization signal detection timings from the synchronization signal detection circuit 802, and outputs the obtained value to the error detection circuit 805 as a synchronization signal period.

The target synchronization signal period setting circuit 804 is a register to which the synchronization signal period to be a reference is recorded, and the period is outputted to the error detection circuit 805.

The error detection circuit 805 is a circuit for comparing the synchronization signal period output from the synchronization signal period measuring circuit 803 to the reference synchronization signal period output from the target synchronization signal period setting circuit 804, and evaluating a difference value therebetween. The second frequency error detection circuit 108′ outputs the difference value as an error amount.

Note that, also in the present embodiment, the circuit of the slice threshold correction for the offset and the asymmetry described in the fourth embodiment can be used.

By using the synchronization signal detection method described above, the period measurement between synchronization signals is stabilized by preventing the false detection due to intersymbol interference, thereby improving the accuracy of the frequency acquisition of the PLL.

### Sixth Embodiment

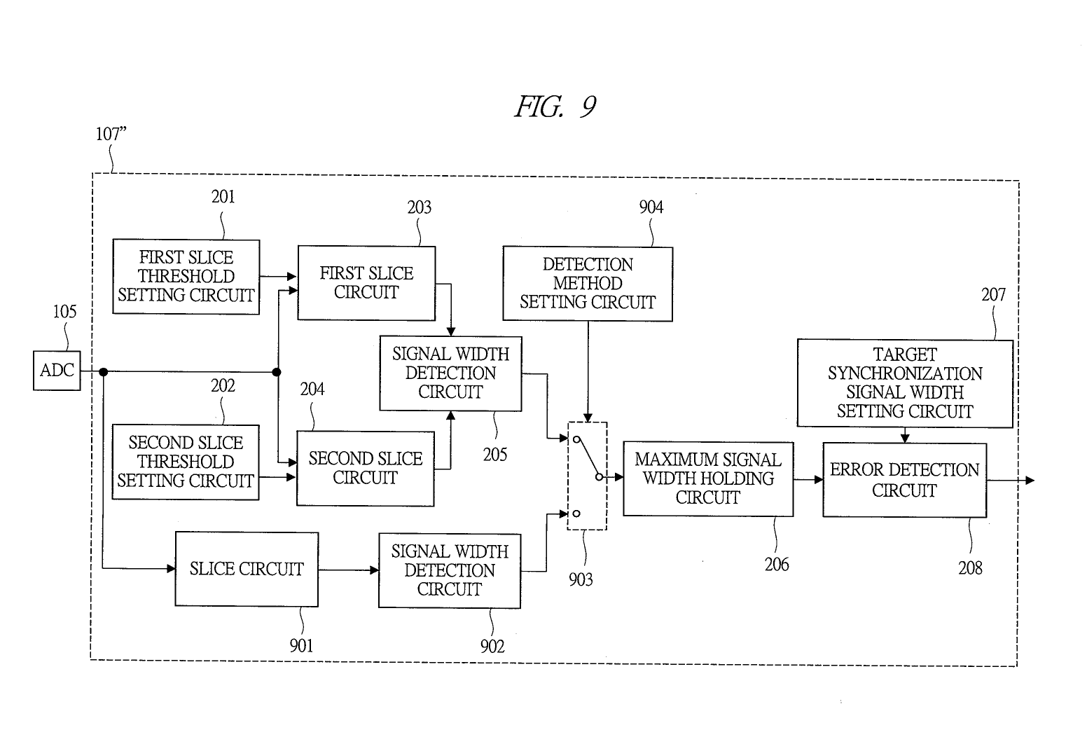

Next, a sixth embodiment of the present invention will be described. An object of the present embodiment is, for example, to switch and use the synchronization signal detection method according to the first embodiment and a synchronization signal detection method according to a conventional method. Differences from the optical disk reproducing device according to the first embodiment are a slice circuit 901, a signal width detection circuit 902, a switch 903, and a detection method setting circuit 904 of FIG. 9. A reproduced signal waveform output from the ADC 105 is sliced at a single level such as the 0 level at the slice circuit 901, and a signal width is detected at the signal width detection circuit 902. An output from the signal width detection circuit 902 and the output from the signal width detection circuit 205 described in the first embodiment are switched at the switch 903. The switching of the outputs is performed with a set value of the detection method setting circuit 904. And, the setting is performed in advance in a register setting and the like by a user, or also can be automatically performed depend on a reproducing speed and a type of reproducing media.

Note that, the switching between the method of the present invention and the conventional method described above is not limited to the first embodiment, and methods of the other embodiments are also applicable in the same manner.

### Seventh Embodiment

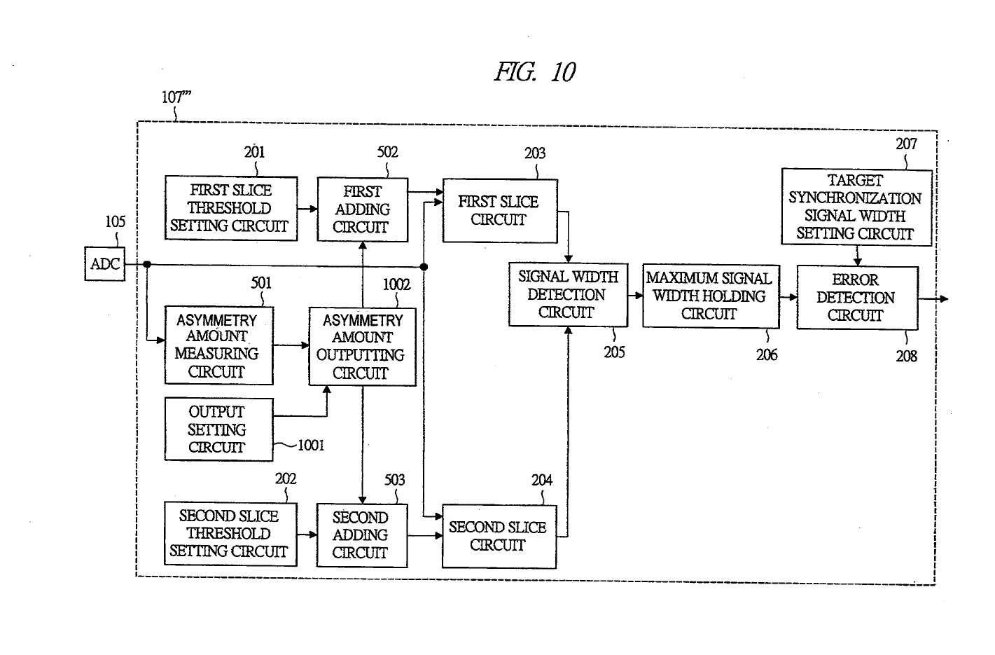

Next, a seventh embodiment of the present invention will be described. An object of the present embodiment is, for example, to switch use/non-use of the asymmetry correction method according to the fourth embodiment. Differences from the optical disk reproducing device according to the fourth embodiment are an output setting circuit 1001 and an asymmetry amount output circuit 1002 of FIG. 10. A user can control the output setting circuit 1001 in advance in a register setting and the like. According to an output from the output setting circuit 1001, the asymmetry amount output circuit 1002 switches whether a correction amount β, which is an output from an asymmetry amount measuring circuit 501, is outputted to the first adding circuit 502 or the second adding circuit 503.

In the foregoing, the invention made by the inventors of the present invention has been concretely described based on the embodiments. However, it is needless to say that the present invention is not limited to the foregoing embodiments and various modifications and alterations can be made within the scope of the present invention.

While an optical disk reproducing device has been especially described in the above descriptions, the application of the present invention is not limited thereto. For example, the present invention is also applicable to a synchronization signal detection in a wireless communication area of mobile phones and others.

What is claimed is:

1. An optical disk reproducing apparatus comprising:
a pickup having a light source for a laser beam and a light receiving part which receives reflected light which is emitted from the light source and reflected from an optical disk, optical information detected by the optical pickup being outputted as an analog signal;
an analog front end which performs an analog processing on the analog signal output from the optical pickup;
a voltage controlled oscillator which outputs a reference frequency;
an analog-to-digital converter which converts an analog signal output from the analog front end into a digital signal by using the reference frequency output from the voltage controlled oscillator;
a frequency error detection circuit which detects a frequency error of an output from the analog-to-digital converter;
a lowpass filter circuit which removes a high frequency component of an output from the frequency error detection circuit; and
a digital-to-analog converter which converts an output from the low-pass filter into an analog signal,
wherein the voltage controlled oscillator outputs the reference frequency based on the analog signal output from the digital-to-analog converter,
wherein the frequency error detection circuit includes:
a first register setting circuit which sets a first threshold;
a first slice circuit which slices the output from the analog-to-digital converter at the first threshold;
a second register setting circuit which sets a second threshold;
a second slice circuit which slices the output from the analog-to-digital converter at the second threshold;
a signal width detection circuit which detects a signal width from an output from the first slice circuit and an output from the second slice circuit;
a maximum signal width detection circuit which compares the signal width output from the signal width detection circuit to a prior signal width, the maximum signal width detection circuit storing and outputting the larger of the signal width output from the signal width detection circuit and the prior signal width;
a third register setting circuit which sets a target synchronization signal width; and
an error detection circuit which compares an output from the maximum signal width detection circuit to the target synchronization signal width and outputting a difference therebetween, wherein the first threshold and the second threshold are different.

2. An optical disk reproducing apparatus according to claim 1,
wherein the signal width detection circuit detects one signal width by a combination of the output from the first slice circuit and the output from the second slice circuit.

3. An optical disk reproducing apparatus according to claim 1,
wherein the signal width detection circuit detects a first signal width obtained from a combination of edge information of the output from the first slice circuit and edge information of the output from the second slice circuit, and also detects a second signal width obtained from a combination of the edge information of the output of the first slice circuit or a combination of the edge information of the output from the second slice circuit, and outputs the first signal width when a difference between the first signal width and the second signal width is smaller than or equal to an acceptable amount previously set in a register setting circuit to the maximum signal width detection circuit and outputs the second signal width when the difference is larger than the acceptable amount to the maximum signal width detection circuit.

4. An optical disk reproducing apparatus according to claim 1,
wherein the signal width detection circuit detects:
a first signal width by a combination of edge information of the output from the first slice circuit;
a second signal width by a combination of the edge information of the output from the second slice circuit; and
a third signal width for a plurality of marks by a combination of the edge information of the output from the first slice circuit and the edge information of the output from the second slice circuit, and the signal width detection circuit outputs the third signal width when a difference between the third signal width and a sum of the first signal width and the second signal width is smaller than or equal to an acceptable value previously set in a fourth register setting circuit.
